(19) United States
(12) Patent Application Publication
(10) Pub. No.: US 2011/0270840 A1
(43) Pub. Date: Nov. 3, 2011

(54) Device and Application for the Retrieval of Catalog Information

(76) Inventor: Charles J. Frasure, Blackfoot, ID (US)

(21) Appl. No.: 13/097,422

(22) Filed: Apr. 29, 2011

Related U.S. Application Data
(60) Provisional application No. 61/329,872, filed on Apr. 30, 2010.

(51) Int. Cl. G06F 17/30

(52) U.S. Cl. 707/740; 707/E17.089

(57) ABSTRACT

An improved device and application for the retrieval of catalog information enables a physical dimension or other characteristic of an object to be measured or otherwise assessed by the device, and from the physical dimension or other characteristic the application retrieves from the catalog an identification or of the object.

### CROSS-REFERENCE TO RELATED APPLICATIONS

The instant application claims priority from U.S. Provisional Patent Application Ser. No. 61/329,872 filed Apr. 30, 2010, the disclosure of which is incorporated herein by reference.

### BACKGROUND

Numerous machinery components are known to have a service life after which they must be replaced. The period of service for any such component can vary widely depending upon the nature of the component, its application, and numerous other factors. Replacement components may be kept on hand or may need to be ordered from a supplier. However, difficulty has been encountered in determining the precise identification of the replacement component. By way of example, ball bearings, roller bearings, and the like can have similar appearances but are nevertheless different from one another. While documentation that may have been provided with a machine at the time of installation of the machine may include specific information regarding its bearings and other components, such documentation may be unavailable or may be inconvenient to obtain. Similarly, while part numbers and other information may be engraved or otherwise applied to components such as bearings, such information may be difficult or impossible to ascertain due to corrosion, wear, and other factors. As such, an improved methodology for identifying machinery components and other devices is needed.

### BRIEF DESCRIPTION OF THE DRAWINGS

A full understanding of the disclosed and claimed concept can be gained from the following Detailed Description when read in conjunction with the accompanying drawings in which:

FIG. 1 is a schematic depiction of an improved portable electronic device in accordance with the disclosed and claimed concept;

FIG. 2 is a depiction of a ball bearing;

FIG. 3 is a depiction of an exemplary embodiment of the portable electronic device of FIG. 1 being used to measure a first physical dimension of the ball bearing of FIG. 2;

FIG. 4 is a depiction of the device of FIG. 3 being used to measure a second physical dimension of the ball bearing of FIG. 2;

FIG. 5 is a depiction of the device of FIG. 3 being used to measure a third physical dimension of the ball bearing of FIG. 2;

FIG. 6 is a depiction of a rear side of the portable electronic device depicting a display upon which is output a part number of the ball bearing of FIG. 2;

FIG. 7 is a schematic depiction of another embodiment of a portable electronic device on which is executed an application in accordance with the disclosed and claimed concept and that is in wireless communication with a computing device that is remote from the portable electronic device; and

FIG. 8 is an exemplary flowchart depicting certain aspects of an improved method in accordance with the disclosed and claimed concept.

Similar numerals refer to similar parts throughout the specification.

### DETAILED DESCRIPTION

A first embodiment of an improved portable electronic device 4 in accordance with the disclosed concept is depicted schematically in FIG. 1 and is depicted in an exemplary form in use in FIGS. 3-6. The portable electronic device 4 can generally be said to be in the nature of a caliper having an apparatus for electronically detecting and storing a number of physical dimensions of an article such as a ball bearing 28 that is indicated in FIGS. 3-6.

As can be seen in FIG. 1, the exemplary portable electronic device 4 comprises a memory 5, a processor 6, and input/output apparatus 7, and a sensor 8. The memory 5, the input/output apparatus 7, and the sensor 8 are in operative communication with the processor 6. The input/output apparatus 7 comprises a button 24 that is depicted in FIGS. 3-5 and a display 44 that is depicted in FIG. 6.

The sensor 8 can be any of a wide variety of electronic devices that can be used to detect physical characteristics such as physical dimensions. By way of example, the sensor 8 may be in the nature of a rotational sensor having a rotational input element that rotates when a movable portion 12 of the portable electronic device 4 is moved with respect to a fixed portion 9 of the portable electronic device 4. Such a sensor 8 may output an electronic signal or pulse that is detected by the processor 6 for each given rotational angle through which the rotational input element rotates. Numerous other types of sensors may be employed without limitation.

As can be generally understood from FIGS. 3-5, the movable portion 12 is translatable with respect to the fixed portion 9 along an elongated bar 14 of the portable electronic device 4. The bar 14 may additionally include a scale of some type printed thereon, such as would facilitate the visual measurement of an article such as the bearing 28.

As is generally understood, the bearing 28 includes an outer race 32, an inner race 36, and a plurality of rollers 40 such as in the nature of spherical balls, cylindrical or frusto-conic rollers, and the like. In accordance with the disclosed and claimed concept, the portable electronic device 4 can be used to measure the physical dimensions of the bearing 28 and can employ the physical dimensions to retrieve from a database stored in the memory 5 a data record that corresponds with the bearing 28. More particularly, the portable electronic device 4 includes a pair of external calipers 16 and a pair of internal calipers 20 that can be adjusted by translating the movable portion 12 with respect to the fixed portion 9 in such a fashion that the external calipers 16 or the internal calipers 20 engage certain surfaces of an article such as the bearing 28. The button 24 can be pressed to input into the processor 6 the precise physical dimension of the surface or surfaces as detected by the sensor 8.

For example, FIG. 3 depicts the external calipers 16 engaged with the outer race 32 of the bearing 28, at which time the button 24 would be pressed to cause the processor 6 to record the output of the sensor 8 as a first physical dimension of the bearing 28. Similarly, in FIG. 4, the internal calipers 20 are engaged with the inner race 36, and the button 24 would again be pressed to cause the processor 6 to record the output from the sensor 8 as being an inner diameter of the bearing 28. Likewise, FIG. 5 depicts a width of the bearing 28 being detected by engaging the external calipers 16 with the bearing 28 and pressing the button 24 to record the output from the sensor as being another physical dimension of the bearing 28.

Advantageously, each such input of a physical dimension of the bearing 28 can be used to identify in the database that is stored in the memory 5 a particular data record that corresponds with the bearing 28. That is, the pressing of the button 24 three times causes the inputting of three physical dimensions to the processor 6, and the three physical dimensions are then used by the processor 6 to identify a specific data record in the database that is stored in the memory 5. The data record will likely include the same three physical dimensions and will likely additionally include the part number for the bearing 28. The database will include numerous data records for numerous different types of bearings. In order to obtain the part number for any given bearing, the diameters of the inner and outer races and the width of the bearing are input in the fashion indicated above, and the processor 6 will retrieve from the database in the memory 5 the particular data record that corresponds with the three physical dimensions that were input. The part number can then be output on a display 44 of the input/output apparatus 7 that, in the exemplary embodiment depicted herein, is disposed on a rear surface of the fixed portion 9 of the portable electronic device 4 as is indicated generally in FIG. 6.

It is understood that numerous different embodiments of the portable electronic device 4 can be developed within the scope of the disclosed and claimed concept. Numerous different types of sensors can be employed, and the physical dimensions or other physical characteristics of article other than bearings can be input in numerous fashions. For instance, the sensor could be optical in nature and employ a laser or other type of output to detect dimensions. Similarly, the sensor could be optical in nature and detect a color as a physical characteristic of an article. Other exemplary physical characteristics that might be input in other embodiments of the portable electronic device would include weight, temperature, electrical resistance (such as in ohms) and the like without limitation and in any combination, and it is understood that additional and other characteristics may be usable to identify a particular data record that corresponds with a given article that is under analysis.

The portable electronic device 4 in the exemplary embodiment depicted herein has the database stored in the memory 5. It is understood that the database of data records need not necessarily be stored directly on the portable electronic device and rather could be accessed from a remote computing device such as with the use of a wireless communication link or other type of communication.

The sensitivity of the sensor 8 can vary with the precision required to identify the article. For example, if the article is one of only a dozen articles, all with physical dimensions that vary widely from one another, the sensor may need to be accurate only within a centimeter. Alternatively, if the article is one of thousands of similar articles with similar dimensions, the sensor 8 may need to accurately measure a physical dimension within one micron, by way of example.

The portable electronic device 4 can be purchased by a user in a condition with the database and relevant routines already stored thereon, or it can be purchased by the user with the user later loading onto the portable electronic device 4 the relevant database and routines. Alternatively, the portable electronic device 4 may be provided by a supplier of components to facilitate the identification and ordering of components from that supplier. In this regard, the portable electronic device 4 may additionally include a routine that enables the direct ordering of a replacement of an article once the article has been identified through use of its physical dimensions or other physical characteristics and retrieval of the corresponding data record without additional ordering steps.

An additional embodiment of a portable electronic device 104 in accordance with the disclosed and claimed concept is depicted in schematically in FIG. 7. The portable electronic device 104 is, in the depicted exemplary embodiment, a cellular telephone that is capable of wireless communication with a remote computer 110. The remote computer 110 includes its own memory and processor and can load onto the portable electronic device 104 an application that enables the retrieval of data records from a database. For example, the application may be executable on the portable electronic device 104 to detect the numeric inputting of physical dimensions such as through the typing digits on the keypad of the portable electronic device 104. In such a scenario, an external measuring device such as a ruler, caliper, or other device may be employed with the physical dimensions of an article being visually read by a technician. The technician may then type on the keypad the relevant physical dimensions that were just measured. The portable electronic device 104 can then retrieve from its own memory or from the memory of the remote computer 110 the data record of the database that corresponds with the physical dimensions or other physical characteristics that were typed by the technician. In this regard, it is understood that the database of data records can be stored directly on the portable electronic device 104 or on the remote computer 110. The remote computer 110 can also provide updates to the application or database or both that can be transmitted to the portable electronic device 104.

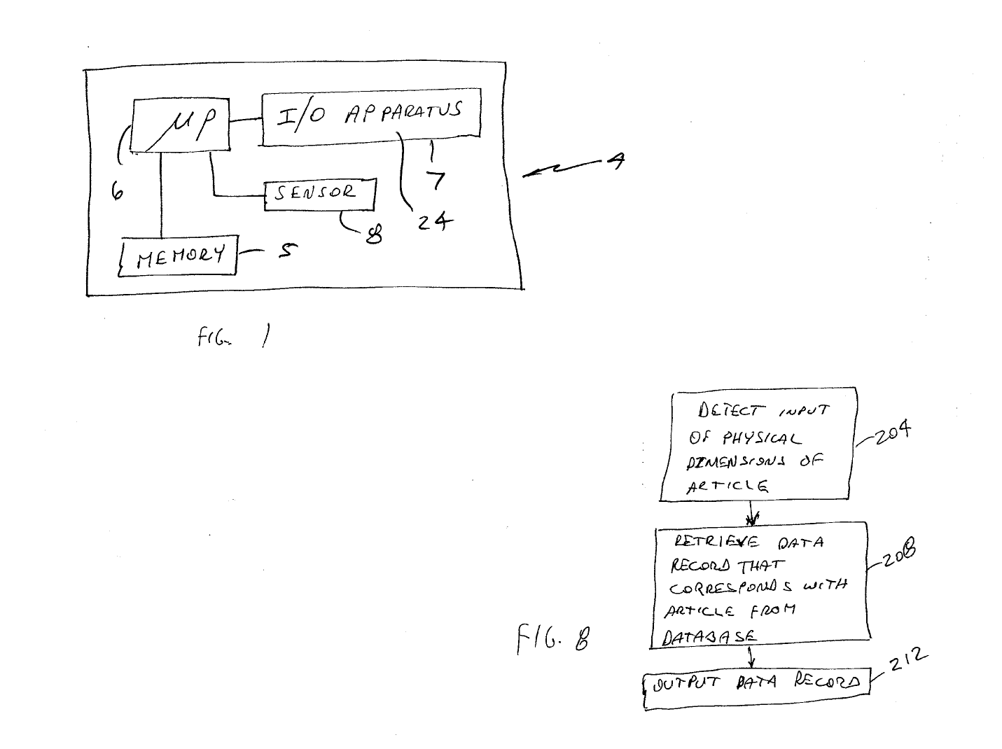

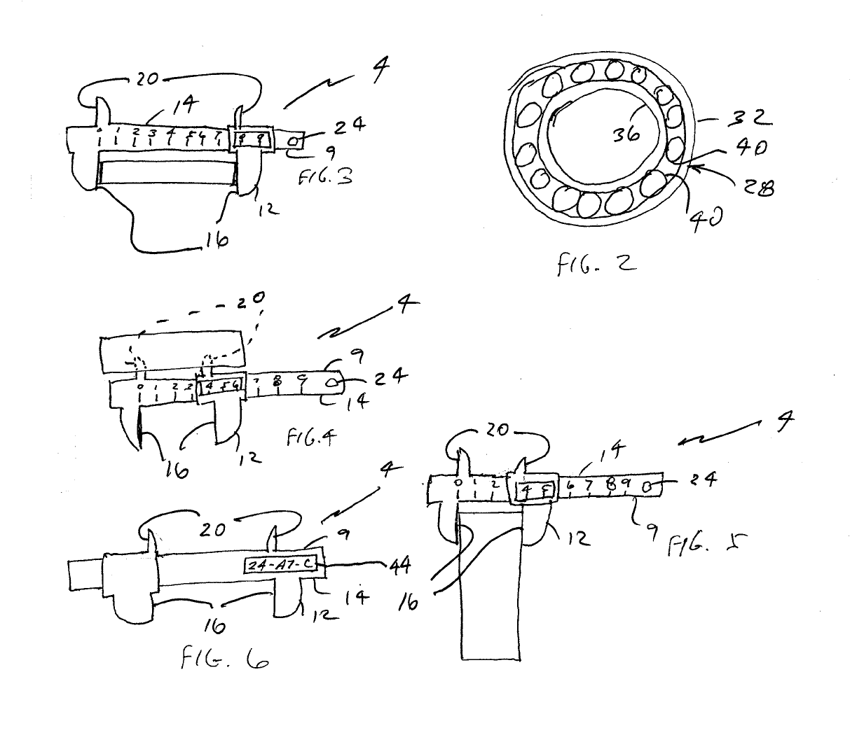

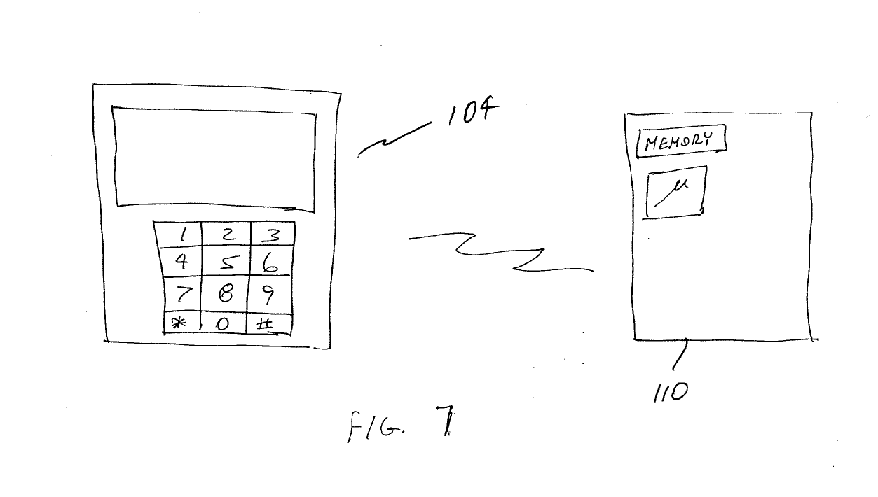

A flowchart depicting certain aspects of an improved method in accordance with the disclosed and claimed concept is depicted generally in FIG. 8. The inputting of a number of physical dimensions of an article is detected, as at 204. The physical dimensions are then employed to retrieve, as at 208, a data record from a database that corresponds with the physical dimensions and that would include a part number or other identification of the article having the same physical dimensions that were detected, as at 204. A portion of the data record can then be output, as at 212. In the example herein, the portion of the data record that is output is the part number, and it can be output on the display 44, as is indicated in FIG. 6. Numerous other types of output, such as audible, vibratory, and the like can be envisioned within the scope of the disclosed and claimed concept.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method of enabling retrieval by a portable electronic device of a data record from a database that is available to the portable electronic device, the method comprising:
detecting input on the portable electronic device of a number of physical dimensions of an article;
employing at least a portion of the number of physical dimensions to retrieve from the database a data record that corresponds with the article; and
outputting at least a portion of the data record.

2. The method of claim 1 wherein the detecting of input comprises detecting input of a number of digits representative of at least a first physical dimension of the number of physical dimensions.

3. The method of claim 1 wherein the detecting of input comprises detecting an output from a sensor that is representative of at least a first physical dimension of the number of physical dimensions.

4. The method of claim 1 further comprising retrieving the data record from a memory of the portable electronic device.

5. The method of claim 1 further comprising retrieving the data record from a storage that is remote from the portable electronic device.

6. The method of claim 5 further comprising wirelessly transmitting between the storage and the portable electronic device a signal that is representative of at least a portion of the number of physical dimensions.

7. The method of claim 5 further comprising wirelessly transmitting between the storage and the portable electronic device a signal that is representative of at least a portion of the number of physical dimensions.

8. A device structured to perform the operations of claim 1.

9. A non-transitory machine readable storage medium comprising instructions which, when executed on a processor of a computing device, causes the computing device to perform the operations of claim 1.

10. A computing device that comprises a processor and a storage having stored therein a database that comprises a plurality of records, at least some of the records each corresponding with an article, the storage further having stored therein instructions which, when executed on the processor, cause the computing device to perform operations comprising:
receiving from an electronic device remote from the computing device a signal representative of a number of physical dimensions of an article;
employing at least a portion of the number of physical dimensions to retrieve from the database a data record that corresponds with the article; and
communicating to the electronic device a signal representative of at least a portion of the data record.

11. The computing device of claim 10, wherein the operations further comprise communicating to the electronic device a signal representative of a number of instructions which, when executed on a processor of the electronic device, cause the electronic device to perform operations comprising:
detecting input on the electronic device of a number of physical dimensions of an article;
communicating to the computing device the signal representative of the number of physical dimensions of the article;
receiving from the computing device the signal representative of at least a portion of the data record; and
outputting at least a portion of the data record.

12. A method of offering articles for sale comprising communicating from a computing device to a portable electronic device a signal comprising instructions which, when executed on a processor of the portable electronic device, cause the portable electronic device to perform the operations of claim 1.

13. A method of enabling retrieval by a portable electronic device of a data record from a database that is stored on the portable electronic device, the method comprising:
detecting input on the portable electronic device of a number of physical characteristics of an article;
employing at least a portion of the number of physical characteristics to retrieve from the database a data record that corresponds with the article; and
outputting at least a portion of the data record.
